(19) United States
(12) Patent Application Publication
(10) Pub. No.: US 2015/0030286 A1
(43) Pub. Date: Jan. 29, 2015

(54) OPTICAL COUPLER, PHOTOELECTRIC CONVERTOR AND OPTICAL COUPLING CONNECTOR

(71) Applicant: HON HAI PRECISION INDUSTRY CO., LTD., New Taipei (TW)

(72) Inventor: I-THUN LIN, Tu-Cheng (TW)

(21) Appl. No.: 14/338,800

(22) Filed: Jul. 23, 2014

(30) Foreign Application Priority Data
Jul. 25, 2013 (TW) 102126592

(51) Int. Cl. G02B 6/42; G02B 6/32

(52) U.S. Cl. CPC G02B 6/4204; G02B 6/32
USPC 385/33; 385/93

(57) ABSTRACT

An optical coupler connector and a photoelectric convertor use an optical coupler to coupler light beams emitted from the light emitters to optical fibers or to couple light beams coming from optical fibers to light receivers. The optical coupler includes a main body and an insertion member that can be releasably connected with the main body, and the optical coupler can use various optical paths.

### FIELD

The present disclosure relates to optical communication systems, and particularly to an optical coupler, a photoelectric convertor and an optical coupling connector.

### BACKGROUND

Optical couplers are used in photoelectric conversion devices and optical coupling connectors. Optical couplers are normally configured to optically couple a photoelectric element with an optical fiber.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is an isometric view of a first embodiment of an optical coupler of the present disclosure.

FIG. 2 is an exploded view of the optical coupler of FIG. 1, the optical coupler including a main body.

FIG. 3 is a cross-sectional view of the main body of the optical coupler of FIG. 2, taken along line III-III.

FIG. 4 is a cross-sectional view of the optical coupler of FIG. 1, taken along line IV-IV.

FIG. 5 is a cross-sectional view of a second embodiment of an optical coupler of the present disclosure.

FIG. 6 is a cross-sectional view of a third embodiment of an optical coupler of the present disclosure.

FIG. 7 is an isometric view of a fourth embodiment of an optical coupler of the present disclosure.

FIG. 8 is an exploded view of the optical coupler of FIG. 7.

FIG. 9 is a cross-sectional view of the optical coupler of FIG. 7, taken along line IX-IX.

FIG. 10 is a cross-sectional view of a first embodiment of an optical coupling connector of the present disclosure.

FIG. 11 is a cross-sectional view of a second embodiment of an optical coupling connector of the present disclosure.

FIG. 12 is a cross-sectional view of a third embodiment of an optical coupling connector of the present disclosure.

FIG. 13 is a cross-sectional view of a fourth embodiment of an optical coupling connector of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a number of” mean “at least two.” The references “substantially” are defined to be essentially conforming to the particular dimension, shape or other word that substantially modifies, such that the component need not be exact. The references “comprising,” when utilized, mean “including, but not necessarily limited to”; it specifically indicates open-ended inclusion or membership in the so-described combination, group, series and the like.

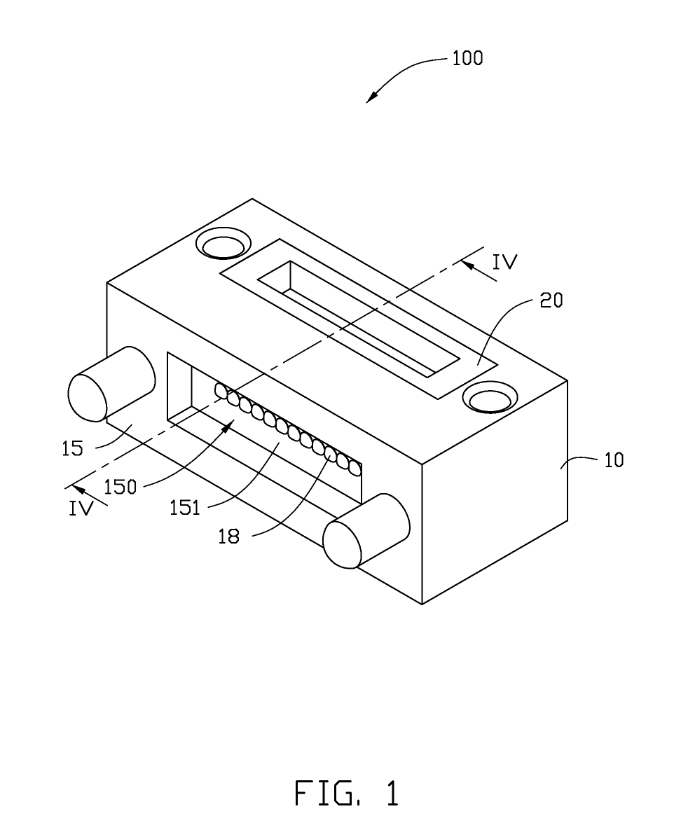

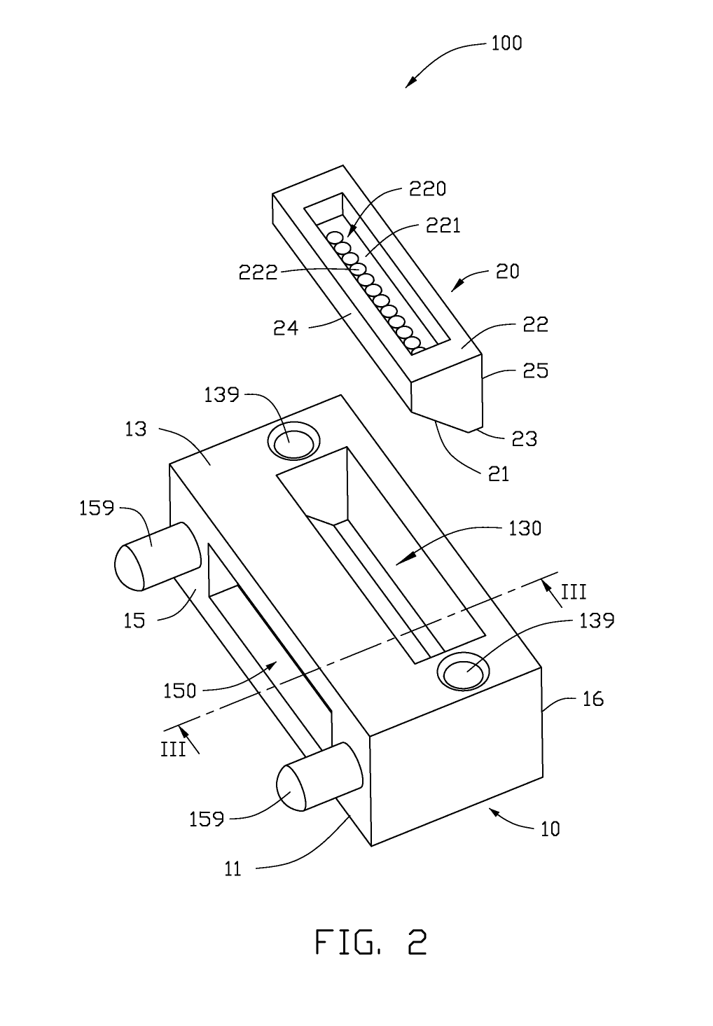

FIGS. 1-4 illustrate a first embodiment of an optical coupler 100. The optical coupler 100 includes a main body 10, an insertion member 20, a number of first convergent lenses 17, a number of second convergent lenses 18, and a number of third convergent lenses 222.

The main body 10 is substantially cuboid. The main body 10 includes a bottom surface 11, a top surface 13 opposite to the bottom surface 11, a front surface 15, and a back surface 16 opposite to the front surface 15. The top surface 13 is substantially parallel to the bottom surface 11. The back surface 16 is substantially parallel to the front surface 15. The front surface 15 and the back surface 16 are connected substantially perpendicular to the bottom surface 11 and the top surface 13.

The main body 10 defines a bottom groove 110 in the bottom surface 11. The bottom groove 110 has a first optical surface 111 formed on a bottom portion of the bottom groove 110. In this embodiment, the first optical surface 111 is substantially parallel to the bottom surface 11.

The main body 10 defines a top groove 130 and two fixing holes 139 in the top surface 13. The top groove 130 includes a first inclined surface 131, a first sidewall 132, a second sidewall 133 and a connecting surface 134. The first inclined surface 131 is positioned on a bottom portion of the top groove 130, the first inclined surface 131 is inclined for substantially 45 degrees relative to the first optical surface 111. In at least one embodiment, the first sidewall 132 and the second sidewall 133 are perpendicularly connected to the top surface 13. The connecting surface 134 is connected between the first inclined surface 131 and the second sidewall 133.

The main body 10 defines a front groove 150 in the front surface 15. The front groove 150 includes a second optical surface 151 formed on a bottom portion of the front groove 150. The second optical surface 151 is substantially perpendicular to the first optical surface 111. In this embodiment, the main body 10 further includes two engaging posts 159 formed on the front surface 15. The two engaging posts 159 are positioned on opposite sides of the front groove 150.

The first convergent lenses 17 are positioned on the first optical surface 111. In this embodiment, the first convergent lenses 17 are arranged along a linear direction substantially parallel to the second optical surface 151.

The second convergent lenses 18 are positioned on the second optical surface 151. In this embodiment, the second convergent lenses 18 are arranged along a linear direction substantially parallel to the first optical surface 111. The second convergent lenses 18 each spatially correspond to one of the first convergent lenses 17.

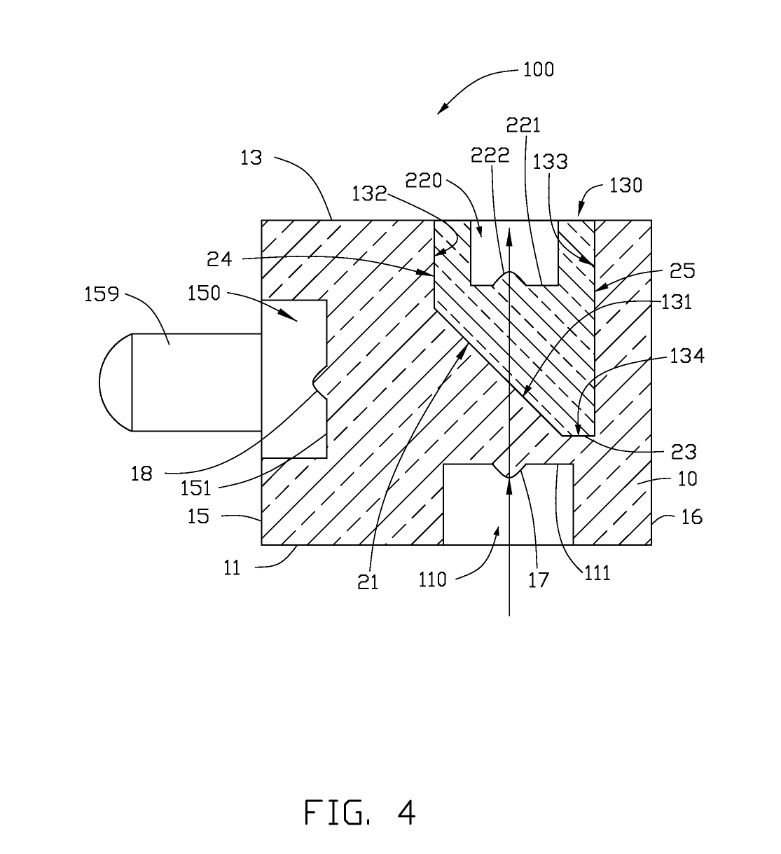

The insertion member 20 can be releasably installed in the top groove 130. The insertion member 20 has a refractive index the same as that of the main body 10. The insertion member 20 includes a second inclined surface 21, a third sidewall 24, a fourth sidewall 25, a lower surface 23 and an upper surface 22. The insertion member 20 defines an upper groove 220 in the upper surface 22. The insertion member 20 includes a third optical surface 221 positioned on a bottom portion of the upper groove 220. When the insertion member 20 is inserted in the top groove 130, the upper surface 22 is coplanar with the top surface 13. Referring to FIG. 4, in this embodiment, the lower surface 23 is releasably attached to the connecting surface 134, the second inclined surface 21 is releasably attached to the first inclined surface 131, the third sidewall 24 is in contact with the first sidewall 132, the fourth sidewall 25 is in contact with the second sidewall 133, and the third optical surface 221 is substantially parallel to the first optical surface 111.

The third convergent lenses 222 are positioned on the third optical surface 221. In this embodiment, when the insertion member 20 is inserted into the top groove 130, the third convergent lenses 222 are arranged along a linear direction substantially parallel to the second optical surface 151. The third convergent lenses 222 each spatially correspond to one of the first convergent lenses 17.

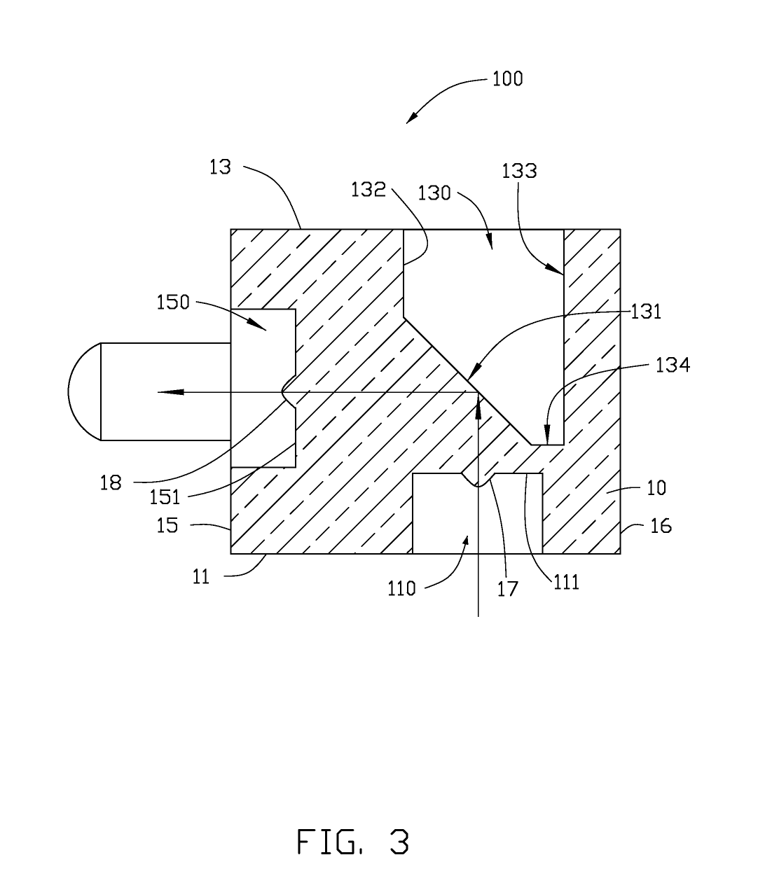

FIG. 3 illustrates a work status of the optical coupler 100 without the insertion member 20. A light beam incident through the first optical surface 111 can be totally reflected by the first inclined surface 131, and the light beam then reflected by the first inclined surface 131 can emerge out through the second optical surface 151. In detail, the light beam passing through the first optical surface 111 can be converged by the first convergent lenses 17, and the light beam passing through the second optical surface 151 can be converged by the second convergent lenses 18. In other embodiments, as light path is reversible, light beam incident through the second optical surface 151 can also be totally reflected by the first inclined surface 131, and the light beam then reflected by the first inclined surface 131 can emerge out through the first optical surface 111.

FIG. 4 illustrates another optical coupler 100 with the insertion member 20 received in the top groove 130. A light beam incident through the first optical surface 111 can pass through the first inclined surface 131 and the second inclined surface 21. The light beam passing through the second inclined surface 21 projects on the third optical surface 221 and emerges out through the third optical surface 221. In detail, the light beam passing through the first optical surface 111 can be converged by the first convergent lenses 17, and the light beam passing through the third optical surface 221 can be converged by the third convergent lenses 222.

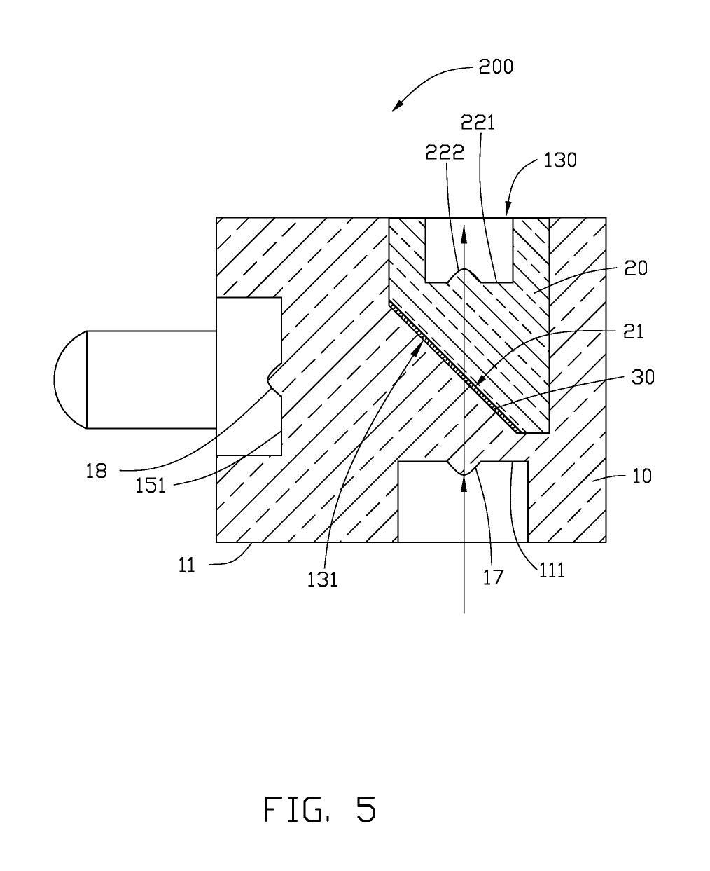

FIG. 5 illustrates a second embodiment of an optical coupler 200, the optical coupler 200 is substantially the same as the optical coupler 100 of the first embodiment, except that the optical coupler 200 further includes an optical matching adhesive 30 formed between the first inclined surface 131 and the second inclined surface 21. The optical matching adhesive 30 has a refractive index the same as that of the main body 10 and the insertion member 20.

In operation, a light beam incident through the first optical surface 111 can pass through the first inclined surface 131, the optical matching adhesive 30 and the second inclined surface 21. The light beam passing through the second inclined surface 21 projects on the third optical surface 221 and emerges out through the third optical surface 221. In detail, the light beam passing through the first optical surface 111 can be converged by the first convergent lenses 17, and the light beam passing through the third optical surface 221 can be converged by the third convergent lenses 222. In other embodiments, as light path is reversible, the light beam incident through the third optical surface 221 can pass through the second inclined surface 21, the optical matching adhesive 30 and the first inclined surface 131. The light beam passing through the first inclined surface 131 projects on the first optical surface 111 and emerges out through the first optical surface 111.

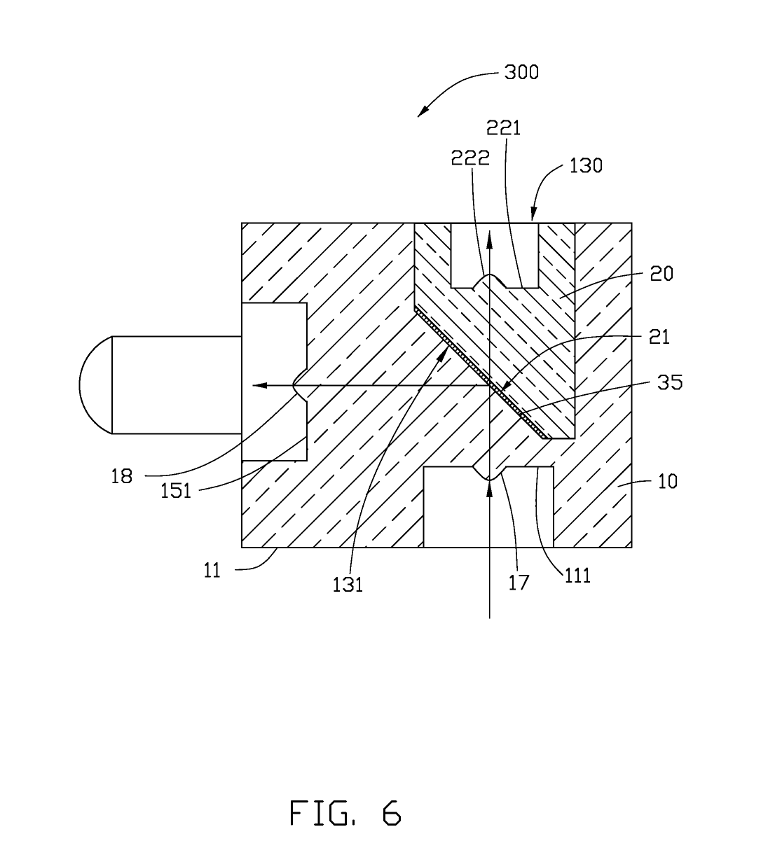

FIG. 6 illustrates a third embodiment of an optical coupler 300, the optical coupler 300 is substantially the same as the optical coupler 100 of the first embodiment, except that the optical coupler 300 further includes an optical splitting film 35 positioned between the first inclined surface 131 and the second inclined surface 21. The optical splitting film 35 is configured to split a light beam incident through the first optical surface 111 into a first light beam portion and a second light beam portion according to a predetermined ratio.

In operation, a light beam incident through the first optical surface 111 projects on the first inclined surface 131, the light beam is then split by the optical splitting film 35 into a first light beam portion and a second light beam portion according to a predetermined ratio. The first light beam portion is reflected to the second optical surface 151. The second light beam portion passes through the optical splitting film 35 and the second inclined surface 21. The first light beam portion emerges out through the second optical surface 151. The second light beam portion emerges out through the third optical surface 221. In detail, the light beam passing through the first optical surface 111 can be converged by the first convergent lenses 17, the first light beam portion passing through the second optical surface 151 can be converged by the second convergent lenses, and the second light beam portion passing through the third optical surface 221 can be converged by the third convergent lenses 222.

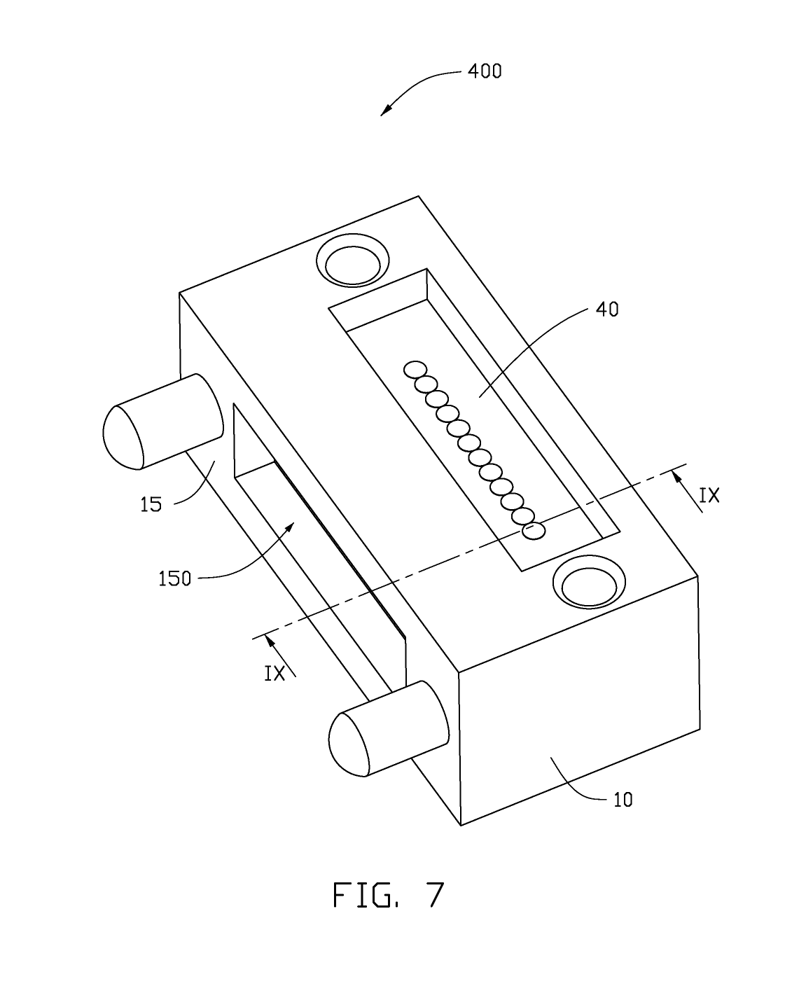

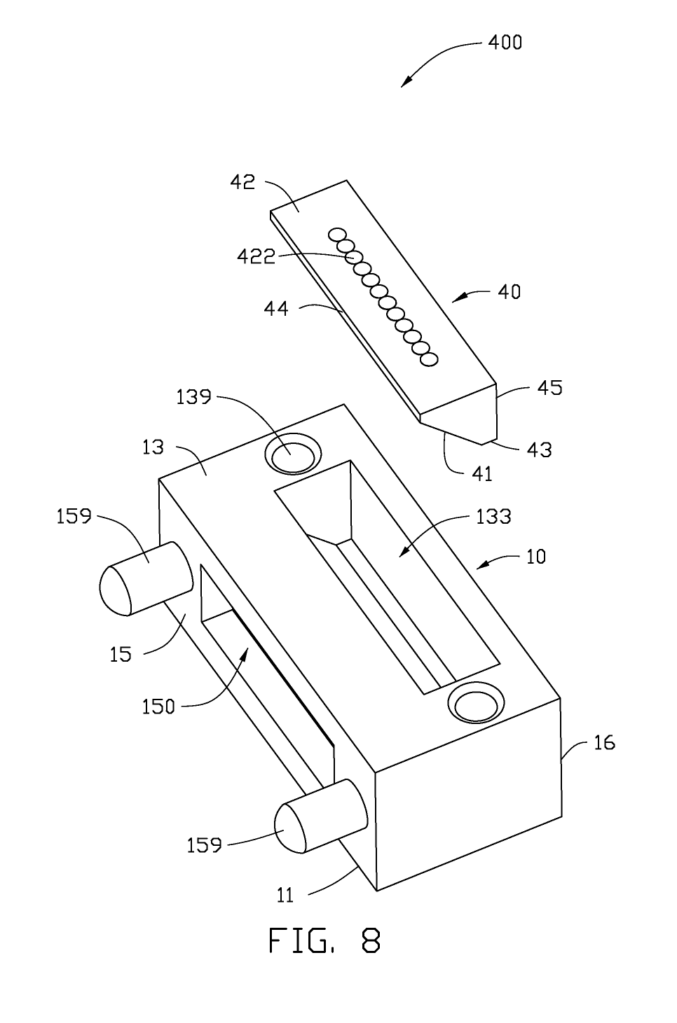

FIGS. 7-9 illustrate a fourth embodiment of an optical coupler 400, the optical coupler 400 is substantially the same as the optical coupler 100 of the first embodiment, except that the optical coupler 400 includes an insertion member 40 instead of the insertion member 20. The insertion member 40 has a refractive index the same as that of the main body 10. The insertion member 40 includes a second inclined surface 41, a third sidewall 44, a fourth sidewall 45, a lower surface 43 and a third optical surface 42. The third optical surface 42 is connected between the third sidewall 44 and the fourth sidewall 45. A number of third convergent lenses 422 are formed on the third optical surface 42. When the insertion member 40 is inserted into the top groove 130, the lower surface 43 is releasably attached to the connecting surface 134, the second inclined surface 41 is releasably attached to the first inclined surface 131, the third sidewall 44 is in contact with the first sidewall 132, the fourth sidewall 45 is in contact with the second sidewall 133, and the third optical surface 42 is substantially parallel to the first optical surface 111. The top groove 130 and the insertion member 40 cooperatively form an upper groove 14. The upper groove 14 is recessed toward the bottom surface 11 relative to the top surface 13. The third optical surface 42 is positioned on a bottom portion of the upper groove 14. The third convergent lenses 422 are arranged along a linear direction substantially parallel to the second optical surface 151, and the third convergent lenses 422 each spatially correspond to one of the first convergent lenses 17.

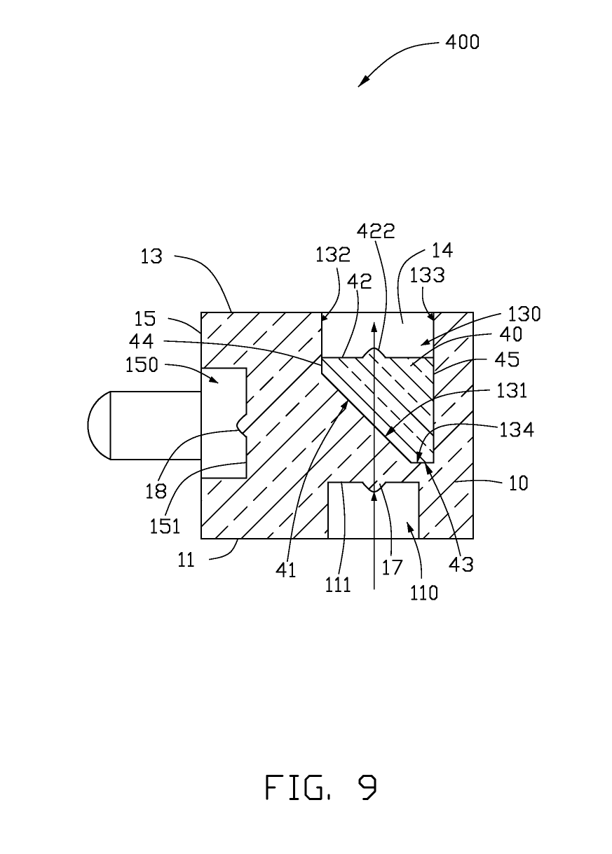

In operation, referring to FIG. 9, when the insertion member 40 is inserted into the top groove 130 and the second inclined surface 41 is in contact with the first inclined surface 131, light beam incident through the first optical surface 111 can pass through the first inclined surface 131 and the second inclined surface 41. The light beam passing through the second inclined surface 41 projects on the third optical surface 42 and emerges out through the third optical surface 42. In detail, the light beam passing through the first optical surface 111 can be converged by the first convergent lenses 17, and the light beam passing through the third optical surface 42 can be converged by the third convergent lenses 422. In other embodiments, light path can also be reversible.

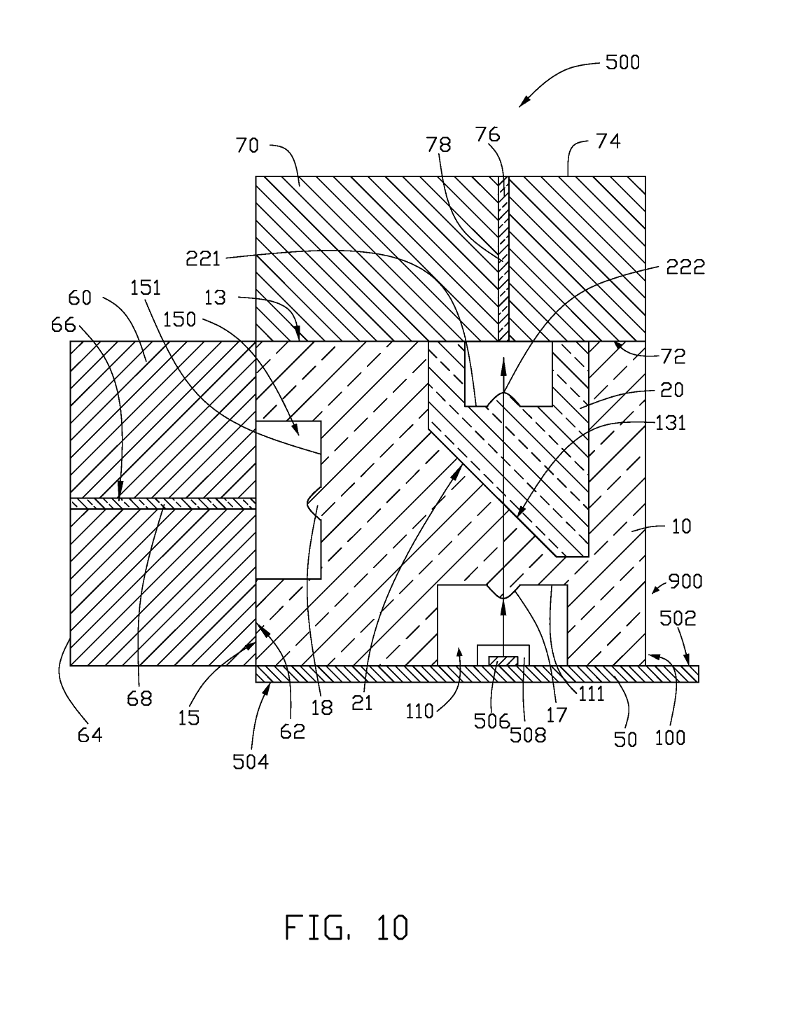

FIG. 10 illustrates a first embodiment of an optical coupling connector 500, the optical coupling connector 500 includes a photoelectric convertor 900, a first receiving member 60, a number of first optical fibers 68, a second receiving member 70, and a number of second optical fibers 78.

The photoelectric convertor 900 includes the optical coupler 100 showed in FIG. 1, a circuit board 50, a number of light emitters 506, and a number of light receivers 508. The circuit board 20 includes a first surface 502 and a second surface 504 opposite to the first surface 502. The optical coupler 100 is positioned on the first surface 502. The light emitters 506 and the light receivers 508 are received in the bottom groove 110. In this embodiment, the light emitters 506 and the light receivers 508 are arranged along a linear direction substantially parallel to the first inclined surface 131. The light emitters 506 and the light receivers 508 each are aligned with one of the first convergent lenses 17. In detail, the number of the light emitters 506 is 6, the number of the light receivers 508 is 6, and the number of the first convergent lenses 17 is 12. The light emitters 506 are configured to convert electrical signals into optical signals and emit light beams containing the optical signals to the first convergent lenses 17. In this embodiment, the light emitters 506 are vertical cavity surface emitting laser (VCSEL). The light receivers 508 are configured to receive light beams and convert optical signals into electrical signals.

The first receiving member 60 includes a third surface 62 and a fourth surface 64 opposite to the third surface 62. The first receiving member 60 defines a number of first receiving holes 66 perpendicularly passing from the third surface 62 through to the fourth surface 64. The first receiving holes 66 are configured to receive the first optical fibers 68. In this embodiment, the first receiving member 60 further defines two installing holes (not shown) in the third surface 62. The two installing holes correspond to the two engaging posts 159. When the two engaging posts 159 are engaged in the two installing holes, the first receiving member 60 is installed with the optical coupler 100, and the third surface 62 is in contact with the front surface 15. The first optical fibers 68 each correspond with one of the second convergent lenses 18.

The second receiving member 70 includes a fifth surface 72 and a sixth surface 74 opposite to the fifth surface 72. The second receiving member 70 defines a number of second receiving holes 76 perpendicularly passing from the fifth surface 72 through to the sixth surface 74. The second receiving holes 76 are configured to receive the second optical fibers 78. In this embodiment, the second receiving member 70 further includes two fixing pins (not shown) formed on the fifth surface 72. When the fixing pins are engaged in the two fixing holes 139, the second receiving member 70 is installed with the optical coupler 100, and the fifth surface 72 is in contact with the top surface 13. When the insertion member 20 is inserted in the top groove 130, the second optical fibers 78 each correspond with one of the third convergent lenses 222.

In operation, when the insertion member 20 is inserted into the top groove 130 and the circuit board 50 is electrically powered, the light emitters 506 emit light beams toward the first optical surface 111. Each light beam passes through the corresponding convergent lenses 17 and projects on the first inclined surface 131. The light beams then pass through the first inclined surface 131 and the second inclined surface 21 and emerges out through the third optical surface 221. The third convergent lenses 222 converge the light beams to the second optical fibers 78 accordingly. In other embodiments, when the insertion member 20 is not inserted into the top groove, the light beams pass through the corresponding convergent lenses 17 and project on the first inclined surface 131, the light beams are then totally reflected by the first inclined surface 131 and emerge out through the second optical surface 151. The second convergent lenses 18 converge the light beams to the first optical fibers 68 accordingly. In other embodiment, as light path is reversible, light beam coming from the second optical fiber 78 which corresponds to the light receiver 508 can pass through the third optical surface 221 and project on the second inclined surface 131. The light beam then passes through the second inclined surface 131 and the first inclined surface 21 and emerges out through the first optical surface 111. The light beam emerging out through the first optical surface 111 can be received by the corresponding light receiver 508.

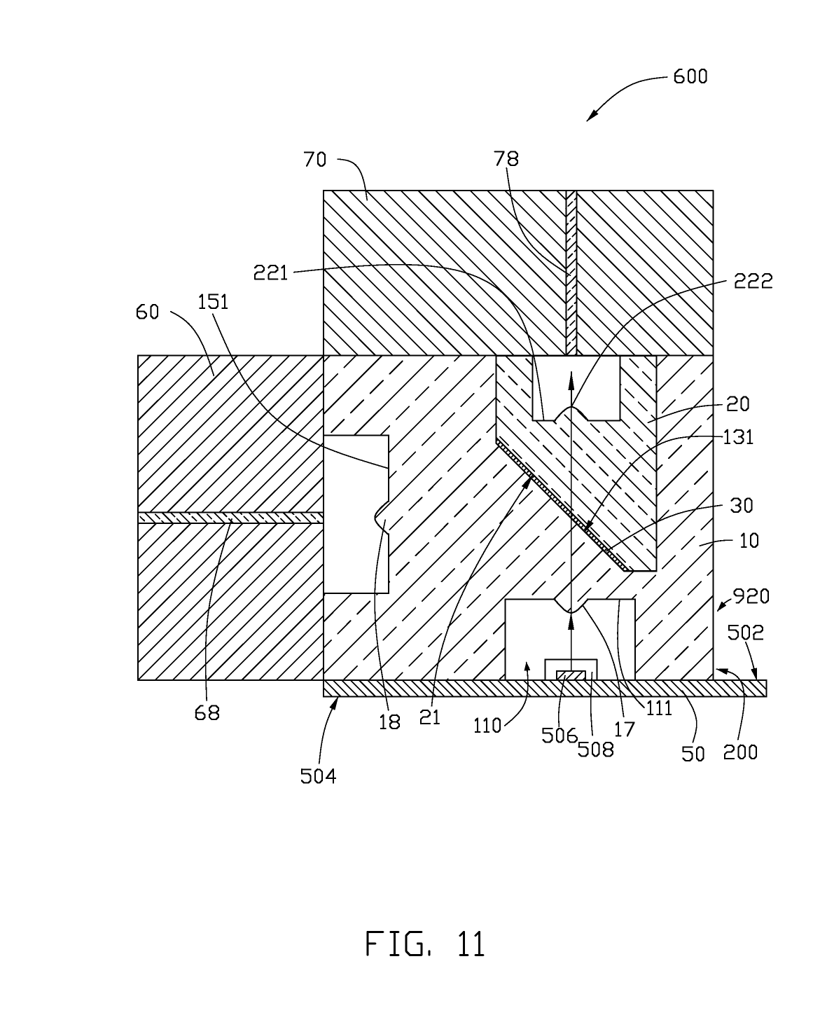

FIG. 11 illustrates a second embodiment of an optical coupling connector 600, the optical coupling connector 600 is substantially the same as the optical coupling connector 500, except that the optical coupling connector 600 includes a photoelectric convertor 920 instead of the photoelectric convertor 900. The photoelectric convertor 920 is substantially the same as the photoelectric convertor 900, except that the photoelectric convertor 920 includes the optical coupler 200 showed in FIG. 5 instead of the optical coupler 100 showed in FIG. 1.

In operation, when the circuit board 50 is electrically powered, the light emitters 506 emit light beams toward the first optical surface 111. Each light beam passes through the corresponding convergent lens 17 and projects on the first inclined surface 131. The light beams then pass through the first inclined surface 131, the optical matching adhesive 30 and the second inclined surface 21 and emerges out through the third optical surface 221. The third convergent lenses 222 converge the light beams to the second optical fibers 78 accordingly. In other embodiment, as light path is reversible, light beam coming from the second optical fiber 78 which corresponds to the light receiver 508 can pass through the third optical surface 221 and project on the second inclined surface 131. The light beam then passes through the second inclined surface 131, the optical matching adhesive 30 and the first inclined surface 21 and emerges out through the first optical surface 111. The light beam emerging out through the first optical surface 111 can be received by the corresponding light receiver 508.

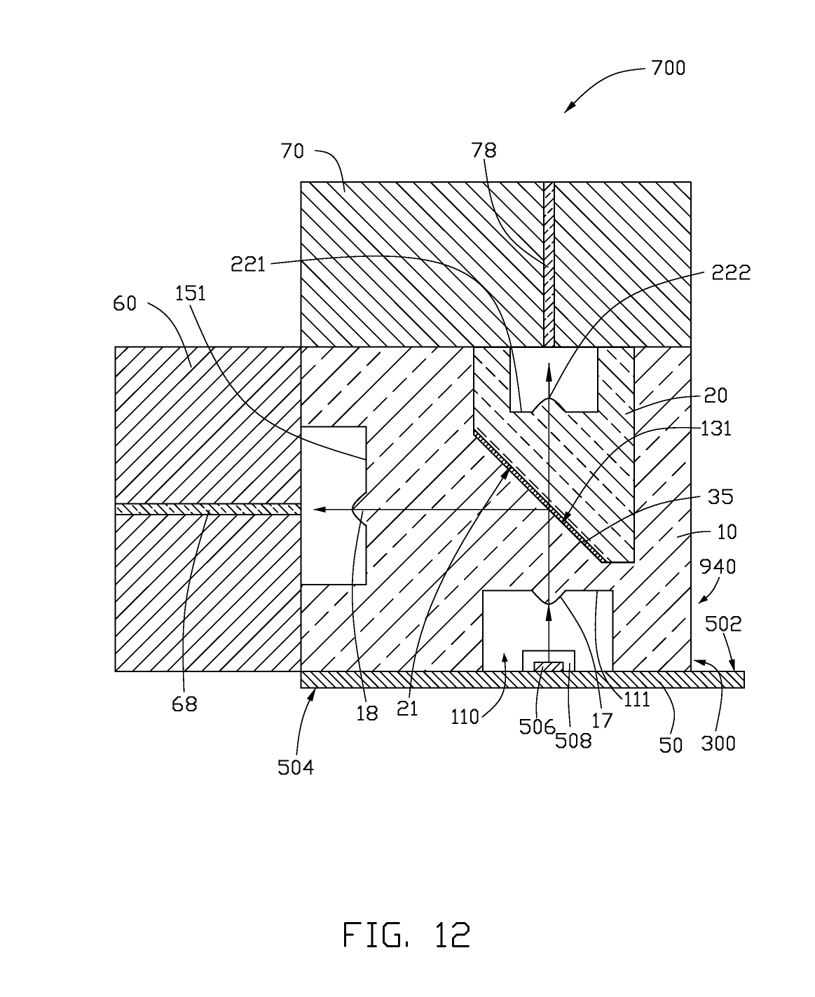

FIG. 12 illustrates a third embodiment of an optical coupling connector 700, the optical coupling connector 700 is substantially the same as the optical coupling connector 500, except that the optical coupling connector 700 includes a photoelectric convertor 940 instead of the photoelectric convertor 900. The photoelectric convertor 940 is substantially the same as the photoelectric convertor 900, except that the photoelectric convertor 940 includes the optical coupler 300 showed in FIG. 6 instead of the optical coupler 100 showed in FIG. 1.

In operation, when the circuit board 50 is electrically powered, the light emitters 506 emit light beams toward the first optical surface 111. Each light beam passes through the corresponding convergent lens 17 and projects on the first inclined surface 131. Each light beam is then split by the optical splitting film 35 into a first light beam portion and a second light beam portion according to a predetermined ratio. The first light beam portion is reflected to the second optical surface 151 and is then converged to the first optical fiber 68 by the second convergent lens 18. The second light beam portion passes through the optical splitting film 35 and the second inclined surface 21 and emerges out through the third optical surface 221. The third convergent lens 222 converges the second light beam portion into the second optical fibers 78.

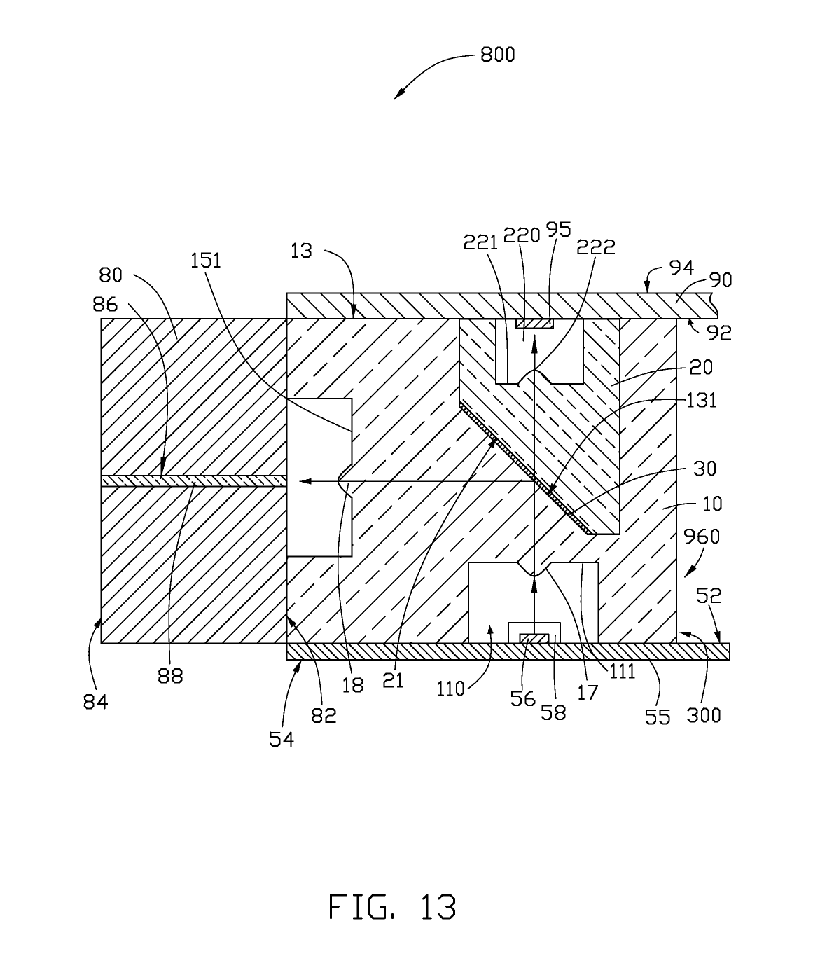

FIG. 13 illustrates a fourth embodiment of an optical coupling connector 800. The optical coupling connector 800 includes a photoelectric convertor 960, a receiving member 80, a number of optical fibers 88, a second circuit board 90 and a number of light detectors 95.

The photoelectric convertor 960 includes the optical coupler 300 showed in FIG. 6, a first circuit board 55, a number of light emitters 56 and a number of light receivers 58. The first circuit board 55 includes a first surface 52 and a second surface 54 opposite to the first surface 52. The optical coupler 300 is positioned on the first surface 52. The light emitters 56 and the light receivers 58 are received in the bottom groove 110. In this embodiment, the light emitters 56 and the light receivers 58 are arranged along a linear direction substantially parallel to the first inclined surface 131. The light emitters 56 and the light receivers 58 each are aligned with one of the first convergent lenses 17. The light emitters 56 are configured to convert electrical signals into optical signals and emit light beams containing the optical signals to the first convergent lenses 17. In this embodiment, the light emitters 56 are vertical cavity surface emitting laser (VCSEL). The light receivers 58 are configured to receive light beams and convert optical signals into electrical signals.

The receiving member 80 includes a third surface 82 and a fourth surface 84 opposite to the third surface 82. The receiving member 80 defines a number of receiving holes 86 perpendicularly passing from the third surface 82 through to the fourth surface 84. The receiving holes 86 are configured to receive the optical fibers 88. In this embodiment, the receiving member 80 further defines two installing holes (not shown) in the third surface 82. The two installing holes correspond to the two engaging posts 159. When the two engaging posts 159 are engaged in the two installing holes, the receiving member 80 is installed with the optical coupler 300, and the third surface 82 is in contact with the front surface 15. The optical fibers 88 each corresponds with the second convergent lenses 18.

The second circuit board 90 includes fifth surface 92 and a sixth surface 94 opposite to the fifth surface 92. In this embodiment, the second circuit board 90 includes two fixing pins (not shown) formed on the fifth surface 92. When the fixing pins are engaged in the two fixing holes 139, the second circuit board 90 is installed with the optical coupler 300, the fifth surface 92 is in contact with the top surface 13. The light detectors 95 are positioned on the fifth surface 92 and received in the upper groove 220. The light detectors 95 are arranged along a linear direction substantially parallel to the second inclined surface 21. The light detectors 95 each correspond with one of the light emitters 56. The light detectors 95 are configured to receive light beams and detect an intensity of each light beam.

In operation, when the circuit board 50 is electrically powered, the light emitters 56 emit light beams toward the first optical surface 111. Each light beam passes through the corresponding convergent lens 17 and projects on the first inclined surface 131. Each light beam is then split by the optical splitting film 35 into a first light beam portion and a second light beam portion according to a predetermined ratio. The first light beam portion is reflected to the second optical surface 151 and is then converged to the optical fiber 88 by the second convergent lens 18. The second light beam portion passes through the optical splitting film 35 and the second inclined surface 21 and emerges out through the third optical surface 221. The third convergent lens 222 converges the second light beam portion into the light detectors 95.

The above-described optical coupler connector and photoelectric convertor use the optical coupler to coupler light beams emitted from the light emitters to optical fibers or to couple light beams coming from optical fibers to light receivers. As the optical coupler includes a main body and an insertion member that can be releasably connected with the main body, the optical coupler can use various optical paths.

Although numerous characteristics and advantages of the present embodiments have been set forth in the foregoing description, together with details of the structures and functions of the embodiments, the disclosure is illustrative only, and changes may be made in detail, including in the matters of shape, size, and the arrangement of parts within the principles of the disclosure to the full extent indicated by the broad general meaning of the terms in which the appended claims are expressed.

What is claimed is:

1. An optical coupler comprising:
a main body, the main body comprising:
a first optical surface;
a first inclined surface inclined substantially 45 degrees relative to the first optical surface;
a second optical surface substantially perpendicular to the first optical surface;
a number of first convergent lenses formed on the first optical surface;
a number of second convergent lenses formed on the second optical surface, the second convergent lenses each spatially corresponding with one of the first convergent lenses;
an insertion member, the insertion member releasably connected with the main body, the insertion member having a refractive index the same as that of the main body, the insertion member comprising a second inclined surface and a third optical surface, the second inclined surface releasably attached to the first inclined surface, the third optical surface substantially parallel to the first optical surface; and
a number of third convergent lenses formed on the third optical surface, the third convergent lenses each spatially corresponding with one of the first convergent lenses.

2. The optical coupler of claim 1, wherein the optical coupler further comprises an optical matching adhesive formed between the first inclined surface and the second inclined surface, the optical matching adhesive has a refractive index the same as that of the main body and the insertion member.

3. The optical coupler of claim 1, wherein the optical coupler further comprises an optical splitting film formed between the first inclined surface and the second inclined surface, the optical splitting film is configured to split a light beam incident through the first optical surface into a first light beam portion and a second light beam portion according to a predetermined ratio.

4. The optical coupler of claim 1, wherein the main body further comprises a bottom surface, the main body defines a bottom groove in the bottom surface, the first optical surface is positioned on a bottom portion of the bottom groove.

5. The optical coupler of claim 4, wherein the main body further comprises a top surface substantially parallel to the bottom surface, the main body defines a top groove in the top surface, the first inclined surface is positioned on a bottom portion of the top groove.

6. The optical coupler of claim 5, wherein the insertion member further comprises an upper surface, the insertion member defines an upper groove in the upper surface, the third optical surface is positioned on a bottom portion of the upper groove, when the insertion member in inserted in the top groove, the upper surface is co-planar with the top surface.

7. The optical coupler of claim 5, wherein when the insertion member being inserted in the top groove, the insertion member and the top groove cooperatively form an upper groove, the third optical surface is positioned on a bottom portion of the upper groove.

8. A photoelectric convertor comprising:
an optical coupler comprising:
a main body, the main body comprising:
a first optical surface;
a first inclined surface inclined substantially 45 degrees relative to the first optical surface;
a second optical surface substantially perpendicular to the first optical surface;
a number of first convergent lenses formed on the first optical surface;
a number of second convergent lenses formed on the second optical surface, the second convergent lenses each spatially corresponding with one of the first convergent lenses;
an insertion member, the insertion member releasably connected with the main body (10), the insertion member having a refractive index the same as that of the main body, the insertion member comprising a second inclined surface and a third optical surface, the second inclined surface releasably attached to the first inclined surface, the third optical surface substantially parallel to the first optical surface; and
a number of third convergent lenses formed on the third optical surface, the third convergent lenses each spatially corresponding with one of the first convergent lenses;
a number of light emitters;
a number of light receivers; and
a circuit board, the light emitters and the light receivers electrically connected to the circuit board, the optical coupler positioned on the circuit board, the light emitters and the light receivers each being aligned with one of the first convergent lenses.

9. The photoelectric convertor of claim 8, wherein the optical coupler further comprises an optical matching adhesive formed between the first inclined surface and the second inclined surface, the optical matching adhesive has a refractive index the same as that of the main body and the insertion member.

10. The photoelectric convertor of claim 8, wherein the optical coupler further comprises an optical splitting film formed between the first inclined surface and the second inclined surface, the optical splitting film is configured to split a light beam incident through the first optical surface into a first light beam portion and a second light beam portion according to a predetermined ratio.

11. The photoelectric convertor of claim 8, wherein the main body further comprises a bottom surface, the main body defines a bottom groove in the bottom surface, the first optical surface is positioned on a bottom portion of the bottom groove.

12. The photoelectric convertor of claim 11, wherein the main body further comprises a top surface substantially parallel to the bottom surface, the main body defines a top groove in the top surface, the first inclined surface is positioned on a bottom portion of the top groove.

13. The photoelectric convertor of claim 12, wherein the insertion member further comprises an upper surface, the insertion member defines an upper groove in the upper surface, the third optical surface is positioned on a bottom portion of the upper groove, when the insertion member in inserted in the top groove, the upper surface is co-planar with the top surface.

14. The photoelectric convertor of claim 12, wherein when the insertion member being inserted in the top groove, the insertion member and the top groove cooperatively form an upper groove, the third optical surface is positioned on a bottom portion of the upper groove.

15. An optical coupling connector comprising:
an optical coupler comprising:
a main body, the main body comprising:
a first optical surface;
a first inclined surface inclined substantially 45 degrees relative to the first optical surface;
a second optical surface substantially perpendicular to the first optical surface;
a number of first convergent lenses formed on the first optical surface;
a number of second convergent lenses formed on the second optical surface, the second convergent lenses each spatially corresponding with one of the first convergent lenses;
an insertion member, the insertion member releasably connected with the main body, the insertion member having a refractive index the same as that of the main body, the insertion member comprising a second inclined surface and a third optical surface, the second inclined surface releasably attached to the first inclined surface, the third optical surface substantially parallel to the first optical surface;
a number of third convergent lenses formed on the third optical surface, the third convergent lenses each spatially corresponding with one of the first convergent lenses;
a number of light emitters;
a number of light receivers;
a circuit board, the light emitters and the light receivers electrically connected to the circuit board, the optical coupler positioned on the circuit board, the light emitters and the light receivers each being aligned with one of the first convergent lenses;
a number of first optical fibers each corresponding with one of the second convergent lenses;
a number of second optical fibers each corresponding with one of the third convergent lenses.

16. The optical coupling connector of claim 15, wherein the optical coupler further comprises an optical matching adhesive formed between the first inclined surface and the second inclined surface, the optical matching adhesive has a refractive index the same as that of the main body and the insertion member.

17. The optical coupling connector of claim 15, wherein the optical coupler further comprises an optical splitting film formed between the first inclined surface and the second inclined surface, the optical splitting film is configured to split a light beam incident through the first optical surface into a first light beam portion and a second light beam portion according to a predetermined ratio.

18. The optical coupling connector of claim 15, wherein the main body further comprises a bottom surface, the main body defines a bottom groove in the bottom surface, the first optical surface is positioned on a bottom portion of the bottom groove.

19. The optical coupling connector of claim 18, wherein the main body further comprises a top surface substantially parallel to the bottom surface, the main body defines a top groove in the top surface, the first inclined surface is positioned on a bottom portion of the top groove.
